(19) United States
(12) Patent Application Publication
(10) Pub. No.: US 2020/0378424 A1
(43) Pub. Date: Dec. 3, 2020

(54) Improvements in Joint Forming Devices

(71) Applicant: Titus d.o.o. Dekani, Dekani (SI)

(72) Inventors: William Ernest Taylor Vallance, Marlow (GB); Valter Svara, Izola (SI); David Pecar, Pobegi (SI); Robert Lukezic, Portoroz (SI)

(21) Appl. No.: 16/607,214

(22) PCT Filed: Apr. 11, 2018
(86) PCT No.: PCT/EP2018/059335

§ 371 Date: Oct. 22, 2019

(30) Foreign Application Priority Data
Apr. 25, 2017 (GB) 1706542.6

(51) Int. Cl. F16B 12/20

(52) U.S. Cl. CPC F16B 12/2036; F16B 2012/2018

(57) ABSTRACT

A device is provided for forming a joint between two panels. The device comprises a fastening element in the form of an elongate dowel (14) within a sleeve (15), and a tightening element in the form of a rotatable cam (10). The dowel (14) has a head (16) at one end for engagement by the cam (10). At its other end, the dowel (14) engages with an expandable section (19) of the sleeve (15) for anchoring the fastening element in a hole in one of the panels. The sleeve (15) is provided with a reduced diameter end section (22), which is arranged to engage in a rebate (27) on the cam (10), with the arrangement thus serving to block lateral movement of the fastening element in a direction transverse to its longitudinal axis.

This invention relates to joint forming devices such as may be used in the furniture industry.

The invention provides a device for forming a joint between two panels, said device comprising a fastening element and a tightening element, the fastening element being elongate and having a head at one end for engaging the tightening element, and a sleeve with an expandable section at the other end for anchoring the fastening element in a hole in one of the panels, the sleeve being arranged to operatively engage the tightening element to block lateral movement of the fastening element in a direction transverse to its longitudinal axis.

By way of example, embodiments of the invention will now be described with reference to the accompanying drawings, in which:

FIGS. 1a and 1b show a tightening element according to the invention,

FIG. 2 shows a first form of fastening element according to the invention,

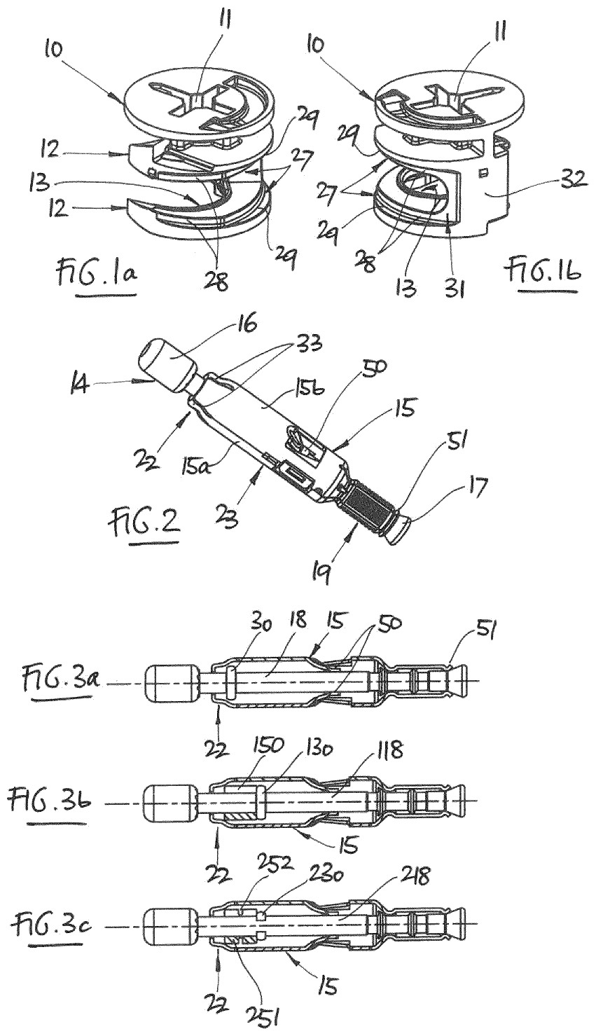

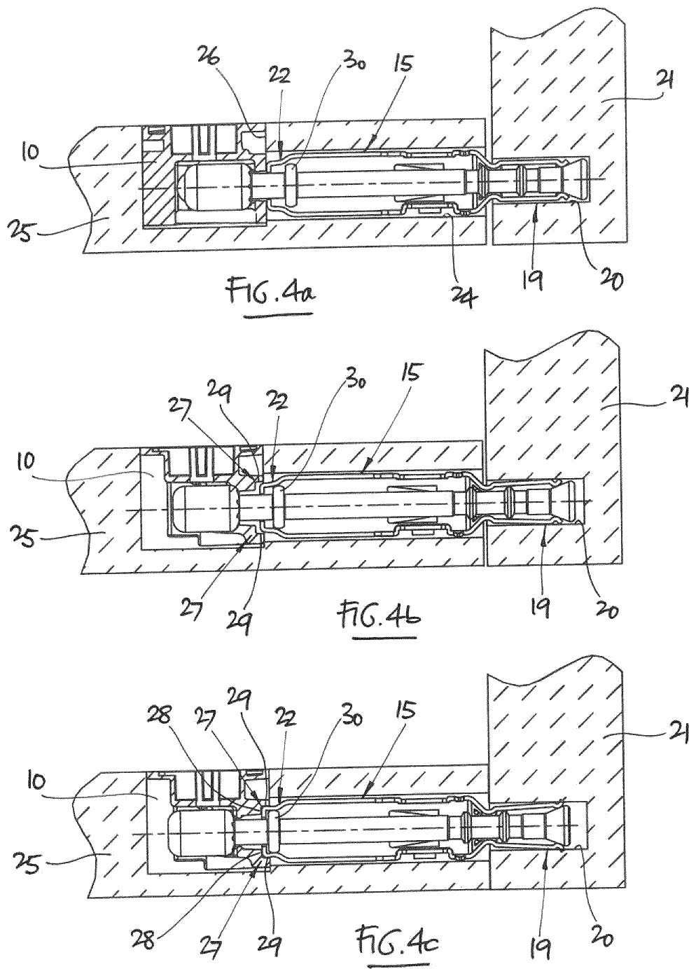

FIG. 3a is a sectional view of the fastening element of FIG. 2,

FIGS. 3b and 3c are sectional views showing alternative configurations of the fastening element of FIG. 3a,

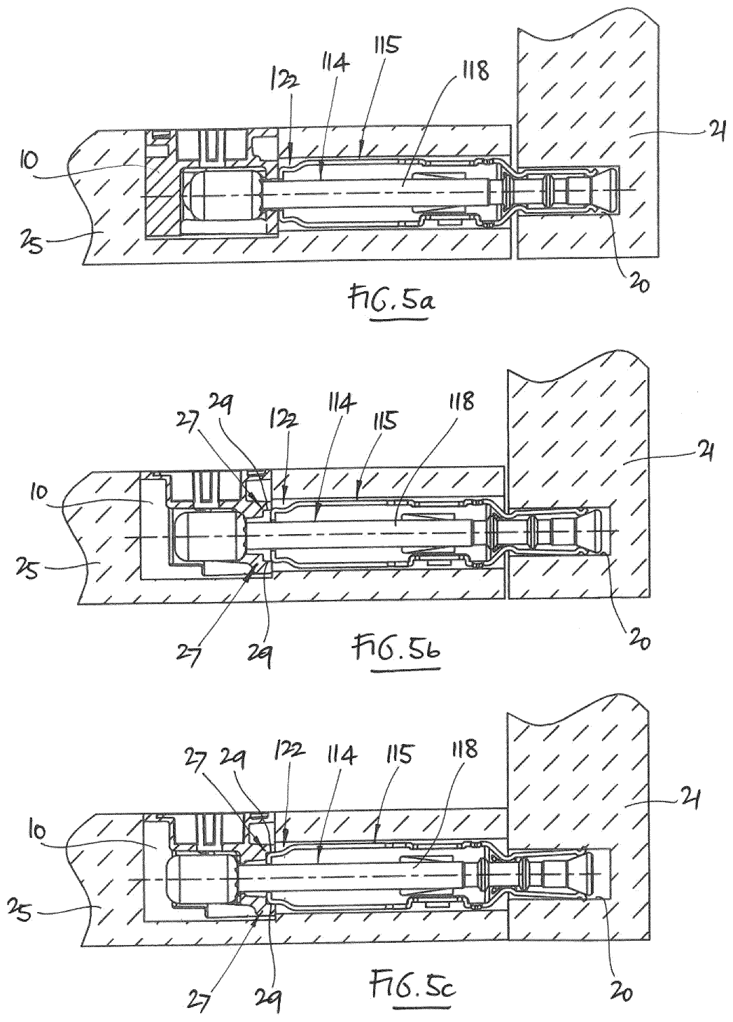

FIGS. 4a to 4c show in cross-sectional detail a joint forming device comprising the tightening element of FIG. 1 and the fastening element of FIGS. 2 and 3a in use between two panels,

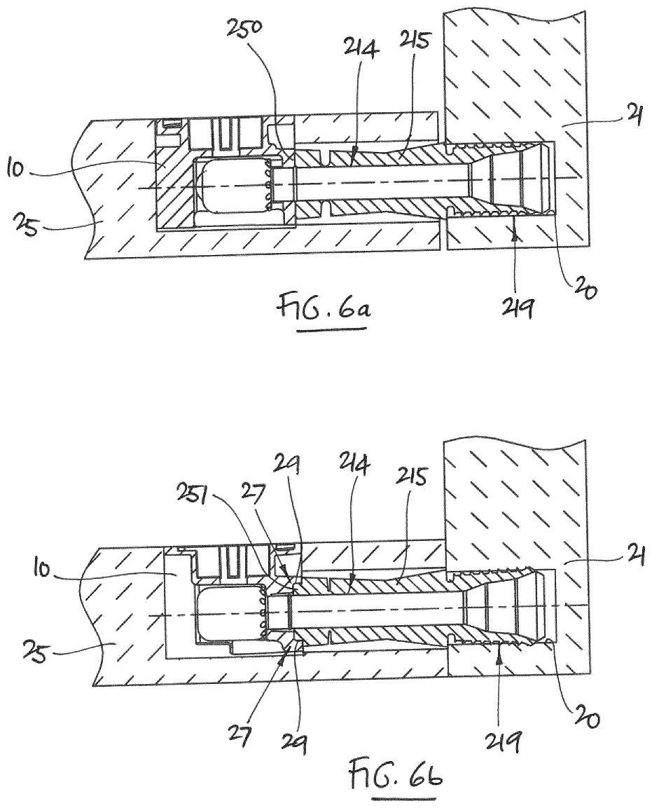

FIGS. 5a to 5c show in cross-sectional detail a joint forming device comprising the tightening element of FIG. 1 and a modified form of fastening element in use between two panels, and

FIGS. 6a and 6b show in cross-sectional detail a joint forming device comprising the tightening element of FIG. 1 and an alternative form of fastening element in use between two panels.

Devices for joining together panels, such as are used for assembly of furniture in factories or at home known as “flat pack” or “ready to assemble” or “knock down” furniture, and which typically comprise a tightening element in the form of a rotatable cam and a fastening element in the form of an elongate sleeved dowel, are well known. In such devices, the fastening element is anchorable at one end in a face hole in one panel, with the cam being mounted in a hole in the other panel and being operatively engageable with the head of the dowel at its other end. Conventionally, such dowels are formed of a metal pin, with an expandable sleeve of metal or plastics material, which can be anchored in the face hole by axial displacement of the dowel relative to the sleeve upon rotation of the cam.

FIGS. 1a and 1b illustrate a form of tightening element for a joint forming device according to the invention. This is in the conventionally familiar form of a generally cylindrical cam 10, with a formation 11 in its upper surface for engagement by a tool such as a screwdriver for rotating the cam about its central axis. The cam 10 incorporates a pair of claw-like projections 12 which are axially spaced apart. On each projection 12 is a camming surface 13. The camming surfaces 13 face generally radially inwardly and extend in a helical path around the axis of the cam 10.

FIGS. 2 and 3a illustrate a form of fastening element for a joint forming device according to the invention. This is in the conventionally familiar form of an elongate dowel 14 with a sleeve 15. In this case, the sleeve 15 is made of metal, conveniently, from die cut and stamped or pressed sheet steel, and formed of two semi-cylindrical shells 15a, 15b.

The dowel 14 has a head 16 at one end to be engaged by the camming surfaces 13 of the cam 10 of FIG. 1 in known manner, an expander 17 at the other end, and a shank 18 extending between the two. Here, the dowel 14 is conveniently made from rolled steel. The expander 17 is of generally known form, with a flared, bell-shaped end. The conical shape of the expander 17 effectively forms a reaction surface for the outward expansion of the sleeve 15. The sleeve 15 is preferably one that comprises a cutting edge 51 at its free end, as disclosed in our co-pending application WO 2016/092105.

The sleeve 15 is provided with inwardly extending spring fingers 50 to engage the shank 18 of the dowel 14 with spring force. In this case, there are two fingers 50 arranged diametrically opposite one another in a mid-section of the sleeve 15, ie intermediate its ends. The point of the fingers 50 is to help with centering the sleeve 15 relative to the dowel 14, ie keeping their longitudinal axes in line. This is particularly useful in the form of sleeve used in the device of FIGS. 5a, 5b and 5c, where additional clearance is needed between its end section 122 and the shank 118 of the dowel 114 to accommodate its inward movement into the rebates 27.

The sleeve 15 has two main sections. At one end is its expandable section 19: this part is designed to fit into a face hole 20 in a first panel 21 (as seen in FIG. 4a) and to expand upon rotation of the cam 10 to anchor the fastening element to the panel, in known manner. At its other end, the sleeve 15 has a reduced diameter end section 22: this part is designed to co-operate with the cam 10, as described below. In between, the sleeve 15 is of generally plain cylindrical form 23 and is designed to fit snugly in an edge hole 24 in the second panel 25 (as seen in FIG. 4a). The edge hole 24 communicates with a face hole 26 in the second panel 25, with the face hole rotatably mounting the cam 10.

The dowel 14 engages with the cam 10 in known manner, with the pair of camming surfaces 13 acting on the head 16 of the dowel to cause its axial displacement upon rotation of the cam, with the end section 22 of the sleeve 15 abutting against the cam.

It will be seen in FIGS. 1a and 1b that the projections 12 each have a rebate 27 cut into the outer surface of the cam 10 along their oppositely facing edges. The rebates 27 extend partly around the outer circumference of the cam 10 and are joined by a rebated section 31 on the main body 32 of the cam from which the projections 12 extend (as seen in FIG. 1b). The rebates 27 together present radially facing bottom faces 28 and axially facing side faces 29 (relative to the rotational axis of the cam 10). The bottom faces 28 extend in a helical path around the axis of the cam 10, meaning in effect that the depth of the rebates 27 below the outer cylindrical surface of the cam 10 tapers over their extent. The rebates 27 are designed to operatively engage with the sleeve 15, as is explained in more detail below.

As seen in FIG. 3a, a collar 30 is arranged on the shank 18 of the dowel 14 in the region of the reduced diameter end section 22 of the sleeve 15. The collar 30 can be formed integrally with the dowel 14 by any suitable process, such as rolling, stamping or pressing, or else formed separately and attached to it by any suitable means. The collar 30 has an outer diameter that is slightly larger than the inner diameter of the end section 22. The end section 22 is provided with axially extending slots 33, as seen in FIG. 2, to allow it to flex. The purpose of this arrangement is for the collar 30 to cause outward expansion of the slotted end section 22 of the sleeve 15 upon relative axial movement between the sleeve and the dowel 14. The outward expansion of end section 22 is to urge it into forced engagement with the side faces 29 of the rebates 27. This effectively anchors the sleeve 15 to the cam 10 in the set condition of the device.

FIGS. 3b and 3c show alternative forms of collar construction. In FIG. 3b, the collar 130 is located further along the shank 118 of the dowel, and a thrust ring 150 is positioned on the shank between the collar and the end section 22 of the sleeve 15. The thrust ring 150 is designed to act in the same way as the collar 30 seen in FIG. 3a, ie to transmit an outward expansion force to the end section 22 of the sleeve 15.

The thrust ring 150 is preferably made of plastics material, and is conveniently formed with an axially extending slit to allow it to be expanded and snapped over the shank 118 of the dowel. The plastics material is chosen to give the thrust ring 150 capacity for resilient deformation. This is helpful in the setting of the device, because it allows compensation for inaccuracies in the final shape and configuration of the end section 22 of the sleeve 15 which might arise due to manufacturing tolerances.

The alternative form of collar construction seen in FIG. 3c is similar to FIG. 3b, but with a different form of thrust ring 251. Also in this case the collar 230 is shown as formed by a stamping or pressing on the shank 218 of the dowel. The thrust ring 251 is again made of plastics material to be capable of deformation as before. In this case, the thrust ring 251 is designed with circumferential grooves 252 to be additionally deformable in the axial direction, ie partially collapsible along its length. This further assists in compensating during the setting of the device for inaccuracies in the sleeve 15 due to manufacturing tolerances.

FIG. 4a shows the initial position of the two panels 21 and 25, with the cam 10 and fastening element in place, but in the un-set condition of the device, ie before any tightening has taken place. There may typically be a small gap between the panels at this stage. The sleeve 15 is seen in contact with the cam 10, at this stage with the end section 22 abutting against the outer surface of the cam at the free ends of the projections 12, where its outer surface is un-rebated, ie cylindrical (as seen in FIG. 1a).

FIG. 4b shows the position of the panels 21 and 25 after initial rotation of the cam 10. It will be seen that the expandable section 19 has now been expanded outwardly into engagement with the face hole 20 in the first panel 21 by axial movement of the expander 17 relative to the sleeve 15. The axial displacement of the dowel 14 caused by rotation of the cam 10 has also pulled the two panels 21, 25 closer together, reducing the gap between them.

It will be noted that rotation of the cam 10 has brought the rebates 27 round and into engagement with the end section 22 of the sleeve 15. The end section 22 is of a size to allow it to move into the rebates 27 between the side faces 29, ie it is a push fit.

FIG. 4c shows the final position of the panels 21 and 25 in the set condition of the device. Now, the expandable section 19 of the sleeve 15 is fully expanded and anchored in the face hole 20. Due to the increasing depth of the rebates 27 around the cam 10, the gap between the panels 21, 25 has been reduced to zero and in fact, the panels are now being held together under tension.

At this stage, the end section 22 of the sleeve 15 has entered fully into the rebates 27, with the end face of the sleeve in abutting contact with the bottom faces 28. The collar 30 on the dowel 14 has come into engagement with the end section 22 of the sleeve 15, forcing it to flex outwardly and into forcible engagement with the side faces 29 of the rebates 27. This arrangement means that the sleeve 15 is effectively blocked by the physical constraint put upon it by the rebates 27. This gives the joint rigidity. It also serves to eliminate or at least substantially reduce lateral movement or “play” of the fastening element in a direction transverse to its longitudinal axis. With the generally cylindrical section 23 of the sleeve 15 forming a relatively snug fit within the edge hole 24 in the second panel 25, this helps to eliminate or at least substantially reduce the possibility of movement or “play” in the joint between the two panels 21, 25.

The joint seen in FIGS. 5a to 5c is similar to that of FIGS. 4a to 4c, and uses the same cam 10. The difference in this embodiment is that it uses a modified form of fastening element. In this case, the fastening element has a sleeve 115 with a reduced diameter end section 122, which is again slotted, but there is no shoulder on the shank 118 of the dowel 114 to engage it. Instead, the end section 122 has an outer diameter that is slightly larger than the distance between the side faces 29 of the rebates 27, ie it is an over-size fit. This can be seen in FIG. 5b.

What happens in this case, therefore, is that end section 122 is forced to flex inwardly into the rebates 27 as the sleeve 15 is pulled towards the cam 10 by relative axial displacement of the fastening element under the action of the rotating cam. This is seen in FIG. 5c and is the set condition of the device. The net result of the arrangement is similar to the joint of FIGS. 4a to 4c, in that the sleeve 115 is essentially blocked by the physical constraint placed upon it by the rebates 27, again effectively eliminating or at least substantially reducing the possibility of lateral play in the fastening element and hence in the joint between the two panels.

The joint seen in FIGS. 6a and 6b is similar to those of FIGS. 4a to 4c and 5a to 5c, and again uses the same cam 10. The difference is that in this case, the fastening element comprises a dowel 214 with a sleeve 215 that is of plastics material, rather than metal.

The sleeve 215 here has an expandable end region 219 and operates in the conventionally familiar manner of an expander. In the alternative, the fastening element could be one that is provided with a cutting edge on the free end of its sleeve, as in the case of the fastening element seen in FIG. 2. In either case, the operative engagement of the sleeve 215 with the cam 10 involves plastic deformation of the sleeve.

The axial end face 250 of the sleeve 215 is annular, and its outer diameter is greater than the distance between the side faces 29, so that initially it spans over the rebates 27. What happens when the sleeve 215 is pulled towards the cam 10 by relative axial movement of the fastening element under the action of the rotating cam, therefore, is that the end face 250 is caused to plastically deform through being forced into the rebates 27. This is the set condition of the device seen in FIG. 6b. As is seen, a chunk 251 of deformed material from the end face 250 is captured within the rebates 27, putting a physical constraint on the sleeve 215 and thus blocking its lateral movement. The net result of the arrangement is similar to the joints of FIGS. 4a to 4c and 5a to 5c, in that the sleeve 215 is essentially locked to the cam 10, again effectively eliminating or at least substantially reducing the possibility of lateral play in the fastening element and hence in the joint between the two panels.

1. A device for forming a joint between two panels, said device comprising a fastening element and a tightening element, the fastening element being elongate and having a head at one end for engaging the tightening element, and a sleeve with an expandable section at the other end for anchoring the fastening element in a hole in one of the panels, the sleeve being arranged to operatively engage the tightening element to block lateral movement of the fastening element in a direction transverse to its longitudinal axis.

2. A device as claimed in claim 1 wherein said blocking of the lateral movement of the fastening element includes a physical constraint.

3. A device as claimed in claim 2 wherein the tightening element is in the form of a rotatable cam and said physical constraint includes a rebate on the cam.

4. A device as claimed in claim 3 wherein the sleeve is engagable in said rebate with a force fit.

5. A device as claimed in claim 4 wherein the sleeve is capable of being initially inserted into the rebate with a push fit, but is capable of being flexed outwardly to form said force fit.

6. A device as claimed in claim 4 wherein the sleeve is an over-size fit for the rebate, but is capable of flexing inwardly.

7. A device as claimed in claim 4 wherein the sleeve is of plastics material and is partially deformable into the rebate to produce said force fit.

8. A device as claimed in claim 5 wherein the sleeve has a slotted section to allow said flexure.

9. A device as claimed in claim 5 wherein the fastening element has an elongate shank with a reaction surface on it to engage the sleeve to cause its outward flexure.

10. A device as claimed in claim 9 wherein said reaction surface is provided by a collar formed on or fixed on the shank.

11. A device as claimed in claim 9 wherein the shank has a collar formed or fixed on it, with a thrust ring interposed between the collar and the sleeve to provide said reaction surface.

12. A device as claimed in claim 11 where the thrust ring is designed to be partially collapsible along the longitudinal axis of the fastening element.

13. A device as claimed in claim 1 and further comprising means for centering the sleeve relative to the fastening element.

14. A device as claimed in claim 13 wherein said centering means comprises two or more spring fingers on the sleeve.

15. A device as claimed in claim 14 wherein said spring fingers are located in a mid-section of the sleeve.

16. A device as claimed in claim 1 wherein the sleeve has a cutting edge at a free end of its expandable section.

17. A piece of furniture comprising a joint forming device as claimed in claim 1.

18. A device as claimed in claim 6 wherein the sleeve has a slotted section to allow said flexure.
